(19) United States
(12) Patent Application Publication
(10) Pub. No.: US 2019/0282419 A1
(43) Pub. Date: Sep. 19, 2019

(54) Patient Transferral Assembly

(71) Applicant: Kester Okpiabhele, Houston, TX (US)

(72) Inventor: Kester Okpiabhele, Houston, TX (US)

(21) Appl. No.: 15/920,555

(22) Filed: Mar. 14, 2018

(51) Int. Cl. A61G 7/10

(52) U.S. Cl. CPC A61G 7/1023; A61G 7/1051

(57) ABSTRACT

A patient transferral assembly for transferring a patient between a bed and a chair includes a belt that may be worn around a waist of a patient. The belt is gripped by a user when the belt is worn on the patient thereby facilitating the user to lift the patient. A panel is coupled to the belt and is extendable through a crotch of the patient to support a weight of the patient when the user grips the belt to lift the patient. A strap is coupled to the panel and the strap is looped around the belt when the belt is worn around the user's waist. The strap is matable to itself to retain each of the belt, the panel and the strap on the patient when the patient is being transferred between a bed and a chair or vice verse.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR Not Applicable

### BACKGROUND OF THE INVENTION

### (1) Field of the Invention

### (2) Description of Related Art Including Information Disclosed Under 37 CFR 1.97 and 1.98

The disclosure and prior art relates to transferral devices and more particularly pertains to a new transferral device for transferring a patient between a bed and a chair.

### BRIEF SUMMARY OF THE INVENTION

An embodiment of the disclosure meets the needs presented above by generally comprising a belt that may be worn around a waist of a patient. The belt is gripped by a user when the belt is worn on the patient thereby facilitating the user to lift the patient. A panel is coupled to the belt and is extendable through a crotch of the patient to support a weight of the patient when the user grips the belt to lift the patient. A strap is coupled to the panel and the strap is looped around the belt when the belt is worn around the user's waist. The strap is matable to itself to retain each of the belt, the panel and the strap on the patient when the patient is being transferred between a bed and a chair or vice verse.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a patient transferral assembly according to an embodiment of the disclosure.

FIG. 2 is a back view of an embodiment of the disclosure.

FIG. 3 is a front view of an embodiment of the disclosure.

FIG. 4 is a back perspective in-view of an embodiment of the disclosure.

FIG. 5 is a side perspective in-use view of an embodiment of the disclosure.

### DETAILED DESCRIPTION OF THE INVENTION

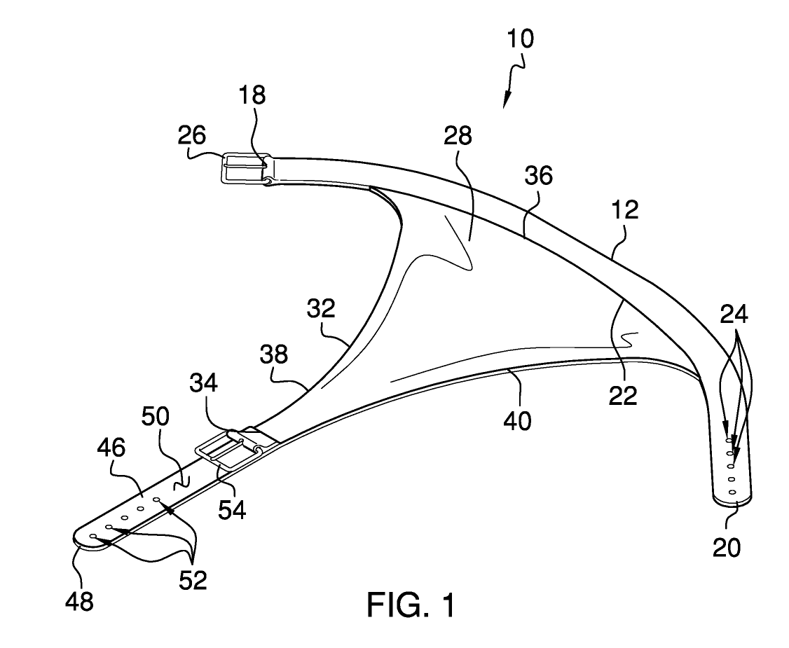

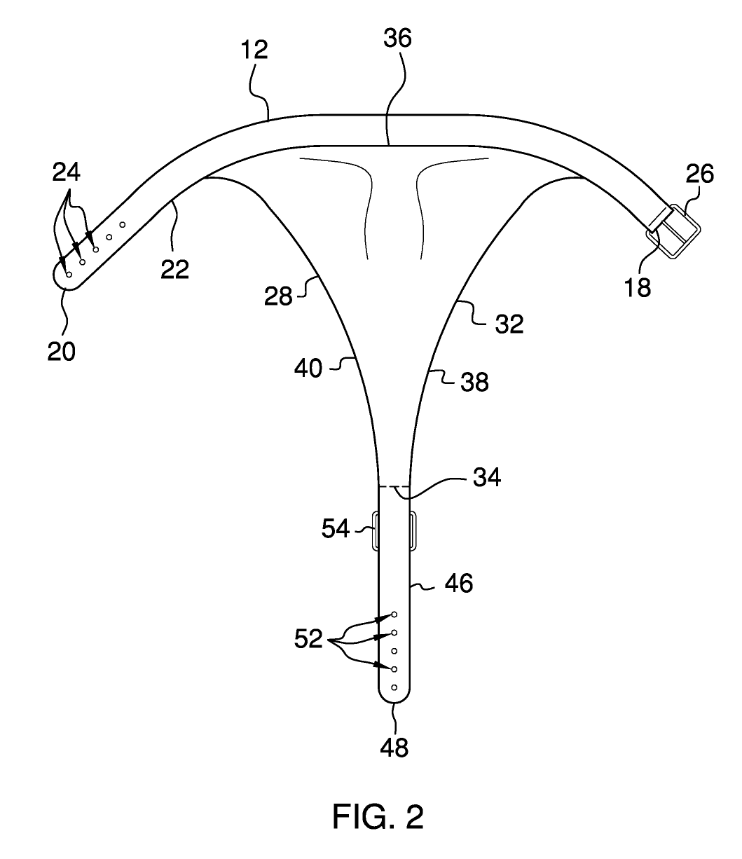

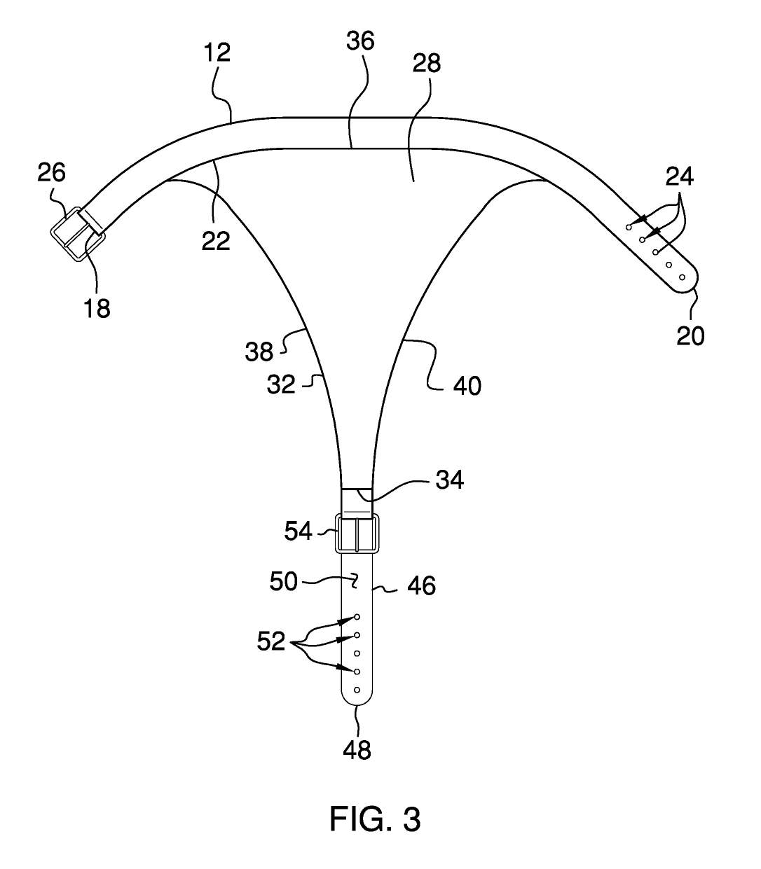

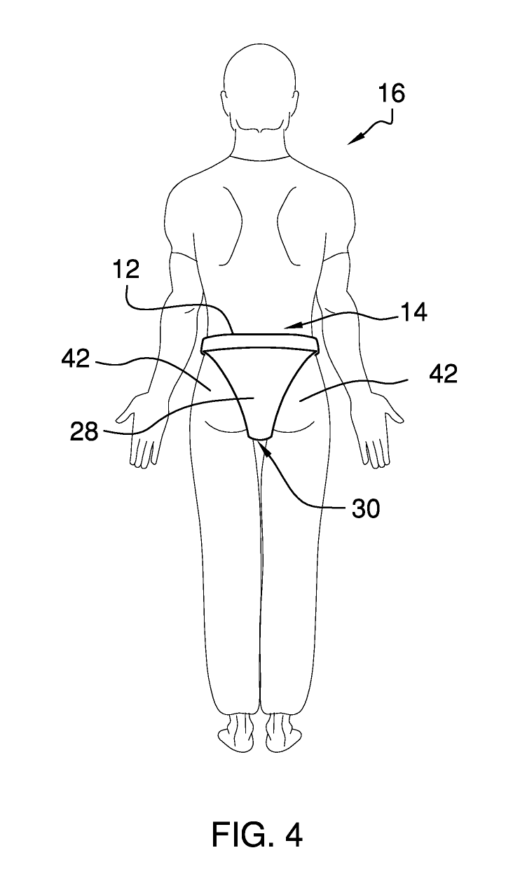

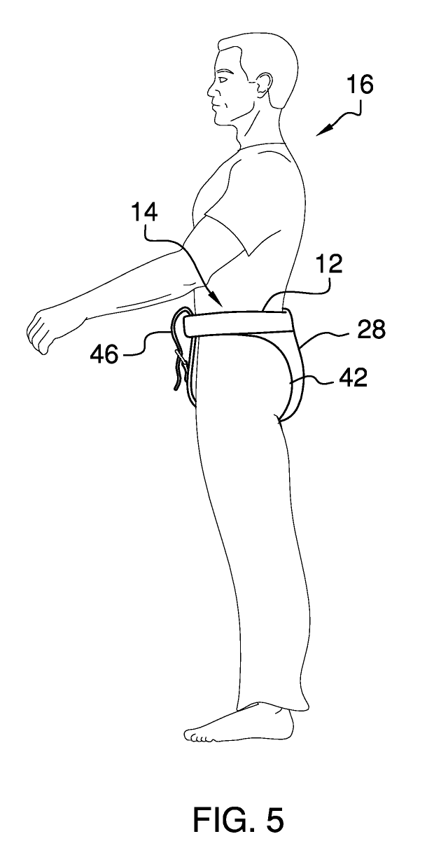

With reference now to the drawings, and in particular to FIGS. 1 through 5 thereof, a new transferral device embodying the principles and concepts of an embodiment of the disclosure and generally designated by the reference numeral 10 will be described.

As best illustrated in FIGS. 1 through 5, the patient transferral assembly 10 generally comprises a belt 12 that may be worn around a waist 14 of a patient 16. The belt 12 is gripped by a user when the belt 12 is worn on the patient 16 thereby facilitating the user to lift the patient 16. The patient 16 may be an individual in a long term health care facility who is not ambulatory and cannot support their own weight. The user may be a caregiver for the patient 16 or the like. The belt 12 may be comprised of leather or other similar flexible material that has a breaking strength of greater than 300.0 pounds.

The belt 12 has a first end 18, a second end 20 and a bottom edge 22 extending therebetween. The belt 12 has a plurality of holes 24 extending therethrough and the holes 24 are spaced apart from each other and are distributed from the second end 20 towards the first end 18. A buckle 26 is coupled to the first end 18 of the belt 12. The second end 20 of the belt 12 is extendable through the buckle 26 and the buckle 26 engages a selected one of the holes 24 to retain the belt 12 around the patient 16's waist 14.

A panel 28 is coupled to the belt 12 and is extendable through a crotch 30 of the patient 16. The panel 28 supports a weight of the patient 16 when the user grips the belt 12 to lift the patient 16. The panel 28 may be comprised of leather or other similar flexible material that has a breaking strength of greater than 300.0 pounds. The panel 28 has a peripheral edge 32 and the peripheral edge 32 has a front side 34, a back side 36, a first lateral side 38 and a second lateral side 40. The back side 36 is coupled to the bottom edge 22 of the first belt 12. Moreover, each of the first lateral side 38 and the second lateral side 40 curves inwardly between the back side 36 and the front side 34 such that the panel 28 has a triangular shape. Thus, the panel 28 conforms to the patient's buttocks 42 and can be extended through the users crotch 30 without impinging on the user's inner thighs 44.

A strap 46 is coupled to the panel 28 and the strap 46 is looped around the belt 12 when the belt 12 is worn around the user's waist 14. The strap 46 is matable to itself to retain each of the belt 12, the panel 28 and the strap 46 on the patient 16 when the patient 16 is being transferred between a bed and a chair or vice verse. The strap 46 may be comprised of leather or other similar flexible material that has a breaking strength of at least 300.0 pounds. The strap 46 is coupled to and extends away from the front side 34 of the panel 28. The strap 46 has a distal end 48 with respect to the front side 34 and a first surface 50 extending between the panel 28 and the distal end 48.

The strap 46 has a plurality of apertures 52 extending therethrough and the apertures 52 are spaced apart from each other and are distributed from the distal end 48 towards the front side 34 of the panel 28. A retainer 54 is coupled to the first surface 50 of the strap 46 and the retainer 54 is aligned with an intersection between the strap 46 and the front side 34 of the panel 28. The distal end 48 of the strap 46 is extended through the retainer 54 when the strap 46 is looped around the belt 12. Additionally, the retainer 54 engages a selected one of the apertures 52 in the strap 46 to retain the strap 46 on the belt 12.

In use, the belt 12 is positioned around the patient 16's waist 14 and the panel 28 is extended downwardly along the user's buttocks 42 and forwardly through the user's crotch 30. The second end 20 of the belt 12 is extended through the buckle 26 to secure the belt 12 around the user's waist 14. The strap 46 is extended upwardly to the belt 12 and looped around the belt 12. Additionally, the distal end 48 of the belt 12 is extended through the retainer 54 to secure the strap 46 around the belt 12. In this way the belt 12, the panel 28 and the strap 46 are retained on the patient 16 for supporting the patient 16's weight. The user grips the belt 12 for lifting the patient 16 and transferring the patient 16 between a bed and a chair or vice verse.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A patient transferral assembly being configured to be worn on a patient thereby facilitating the patient to be transferred from a bed to a chair, said assembly comprising:
a belt being configured to be worn around a waist of a patient, said belt being gripped by a user when said belt is worn on the patient thereby facilitating the user to lift the patient;
a panel being coupled to said belt and being extendable through a crotch of the patient wherein said panel is configured to support a weight of the patient when the user grips said belt to lift the patient; and
a strap being coupled to said panel, said strap being looped around said belt when said belt is worn around the users waist, said strap being matable to itself to retain each of said belt, said panel and said strap on the patient when the patient is being transferred between a bed and a chair or vice verse.

2. The assembly according to claim 1, wherein said belt has a first end, a second end and a bottom edge extending therebetween, said belt having a plurality of holes extending therethrough, said holes being spaced apart from each other and being distributed from said second end towards said first end.

3. The assembly according to claim 2, further comprising a buckle being coupled to said first end of said belt, said second end of said belt being extendable through said buckle having said buckle engaging a selected one of said holes to retain said belt around the patient's waist.

4. The assembly according to claim 2, further comprising said panel having a peripheral edge, said peripheral edge having a front side, a back side, a first lateral side and a second lateral side, said back side being coupled to said bottom edge of said first belt.

5. The assembly according to claim 4, wherein each of said first lateral side and said second lateral side curve inwardly between said back side and said front side such that said panel has a triangular shape wherein said panel is configured to conform to the patient's buttocks and extend through the users crotch.

6. The assembly according to claim 4, wherein said strap is coupled to and extends away from said front side of said panel, said strap having a distal end with respect to said front side and in a first surface extending between said panel and said distal end.

7. The assembly according to claim 6, wherein said strap has a plurality of apertures extending therethrough, said apertures being spaced apart from each other and being distributed from said distal end towards said front side of said panel.

8. The assembly according to claim 7, further comprising a retainer being coupled to said first surface of said strap, said retainer being aligned with an intersection between said strap and said front side of said panel, said distal end of said strap being extendable through said retainer when said strap is looped around said belt, said retainer engaging a selected one of said apertures in said strap to retain said strap on said belt.

9. A patient transferral assembly being configured to be worn on a patient thereby facilitating the patient to be transferred from a bed to a chair, said assembly comprising:
a belt being configured to be worn around a waist of a patient, said belt being gripped by a user when said belt is worn on the patient thereby facilitating the user to lift the patient, said belt having a first end, a second end and a bottom edge extending therebetween, said belt having a plurality of holes extending therethrough, said holes being spaced apart from each other and being distributed from said second end towards said first end;
a buckle being coupled to said first end of said belt, said second end of said belt being extended through said buckle having said buckle engaging a selected one of said holes to retain said belt around the patient's waist;
a panel being coupled to said belt and being extendable through a crotch of the patient wherein said panel is configured to support a weight of the patient when the user grips said belt to lift the patient, said panel having a peripheral edge, said peripheral edge having a front side, a back side, a first lateral side and a second lateral side, said back side being coupled to said bottom edge of said first belt, each of said first lateral side and said second lateral side curving inwardly between said back side and said front side such that said panel has a triangular shape wherein said panel is configured to conform to the patient's buttocks and extend through the users crotch;
a strap being coupled to said panel, said strap being looped around said belt when said belt is worn around the users waist, said strap being matable to itself to retain each of said belt, said panel and said strap on the patient when the patient is being transferred between a bed and a chair or vice verse, said strap being coupled to and extending away from said front side of said panel, said strap having a distal end with respect to said front side and in a first surface extending between said panel and said distal end, said strap having a plurality of apertures extending therethrough, said apertures being spaced apart from each other and being distributed from said distal end towards said front side of said panel; and
a retainer being coupled to said first surface of said strap, said retainer being aligned with an intersection between said strap and said front side of said panel, said distal end of said strap being extended through said retainer when said strap is looped around said belt, said retainer engaging a selected one of said apertures in said strap to retain said strap on said belt.
